(19) United States
(12) Patent Application Publication
(10) Pub. No.: US 2005/0090227 A1
(43) Pub. Date: Apr. 28, 2005

(54) Network brokerage method

(76) Inventors: Chunghwa Heman Rao, Taipei (TW); Sheng-Hsuan Liao, Taipei (TW); Chia-Jung Liang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/674,547

(22) Filed: Oct. 1, 2003

(51) Int. Cl. H04Q 7/20

(52) U.S. Cl. 455/405

(57) ABSTRACT

A method of brokering networks and network services between network companies and virtual network operators in order to leverage the assets of both organizations and facilitate cooperation between the organizations to provide improved network services to subscribers. A network broker mediates between network companies who provide the physical network, and virtual network operators who provide the content and program applications. The network broker can switch between network companies depending upon issues such as cost and can negotiate better rates based on total traffic of a plurality of virtual network operators. The switching can be transparent to the virtual network operators. The network broker can negotiate better rates by combining the total usage of all the virtual network operators.

### BACKGROUND OF THE INVENTION

1. Field of the Invention

The present invention relates to networking methods. More specifically, the present invention discloses a method of providing network brokerage services between network companies and virtual network operators in order to provide networks to network operators who do not have their own physical networks.

2. Description of the Prior Art

Currently, mobile telephone network companies provide numerous services to mobile phone users. Some of these services are placing telephone calls and accessing networks such as a wireless application protocol (WAP) network or the Internet.

While network companies are adept at providing standard telephone network services to subscribers, they tend to be too generalized to offer unique or specialized services. Additionally, most of the network company's resources are spent maintaining, upgrading, and developing their physical network and equipment. As a result, a relatively small amount of effort is put into improving services or developing new services.

However, as the number and sophistication of subscribers grows, demand increases for more specialized or unique services. Since the traditional telephone company is not up to meeting the increasing demand of modem services, other organizations need to get involved in providing specialized services.

However, since the cost of establishing a network and providing network services is very high, these new organizations must find available networks to use for their services.

Therefore, there is a need for a method of providing network company networks and services to virtual network operators by a network broker in order to provide improved communication services to and lower costs for virtual network operators, and subscribers.

### SUMMARY OF THE INVENTION

To achieve these and other advantages and in order to overcome the disadvantages of the conventional method in accordance with the purpose of the invention as embodied and broadly described herein, the present invention provides a method of brokering networks and network services between network companies and virtual network operators in order to leverage the assets of both organizations and facilitate cooperation between the organizations in order to provide improved network services to subscribers.

The method of the present invention comprises a system of providing and controlling networks and network services by multiple operators, virtual operators, and network companies.

The method comprises a network company, a virtual network operator, and a network broker. The network company (NETCO) provides the physical network such as the telephone lines, switches, and satellite equipment as well as various telephone services. This is the standard telephone network operator most commonly thought of as a telephone company.

As described above, for several reasons NETCO's do not usually provide specialized services to subscribers. In order to meet the demands of sophisticated subscribers, virtual network operators can join with NETCO's to provide these specialized services.

A virtual network operator (VNO) is an operator that provides a virtual network to subscribers. To subscribers, the network appears to be a physical network like the NETCO provides but with the additional of unique and specialized services. Since the VNO usually does not have its own network, it needs to lease, rent, or purchase access to and usage of the NETCO's network. The VNO is usually an organization with a well branded name or image, and one which typically wasn't previously associated as a network company. However, since the VNO's brand is well known for other businesses or services, they can obtain a profitable market share by offering network services to subscribers. The VNO provides content, billing services, and customer care, and other special services that are specialized or unique. The VNO provides these services without the expense of establishing their own network.

In order to facilitate negotiation, acquisition, and costing/billing services, the system of the present invention further comprises a network broker. The network broker locates available network services offered by NETCO's and negotiates agreements with the NETCO's for usage of their networks and services. The network broker also locates suitable VNO's and provides the required network and network services to the VNO. Additionally, the network broker can provide assistance to a new VNO in creating and developing the VNO's network services and systems.

In addition to facilitating cooperation between the NETCO's and the VNO's, the network broker is a mediator between the two organizations. As a mediator, the network broker is able to provide services that neither the NETCO's nor the VNO's desire to or are able to provide. For example, the network broker can combine the total usage of a multiple number of VNO's to negotiate better pricing or rates with a NETCO. Without the network broker, each individual VNO needs to negotiate their own agreement with a NETCO for only the individual VNO's usage. This results in a higher cost to each VNO.

The network broker can also switch between a multiple number of NETCO's. This allows the network broker to negotiate between competing NETCO's and switch between available networks for reasons such as lower cost, better rates, higher quality, etc. Also, since issues such as time, date, and location affect costs, the network broker can determine the optimum value and switch between networks as desired.

In certain situations it is desirable that the switching between networks is not apparent to the VNO's. Therefore, the switching can also be performed transparently by the network broker.

Utilizing the method of the present invention, the network broker provides the highest quality of and lowest cost for network and network services to virtual network operators who do not have their own network.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating a network brokering method comprising a network company, a network broker, and a virtual network operator according to an embodiment of the present invention;

FIG. 2 is a block diagram illustrating a network brokering method comprising a network company, a network broker, and a plurality of virtual network operators according to an embodiment of the present invention;

FIG. 3 is a block diagram illustrating a network brokering method comprising a plurality of network companies, a network broker, and a virtual network operator according to an embodiment of the present invention; and

FIG. 4 is a block diagram illustrating a network brokering method comprising a plurality of network companies, a network broker, and a plurality of virtual network operators according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

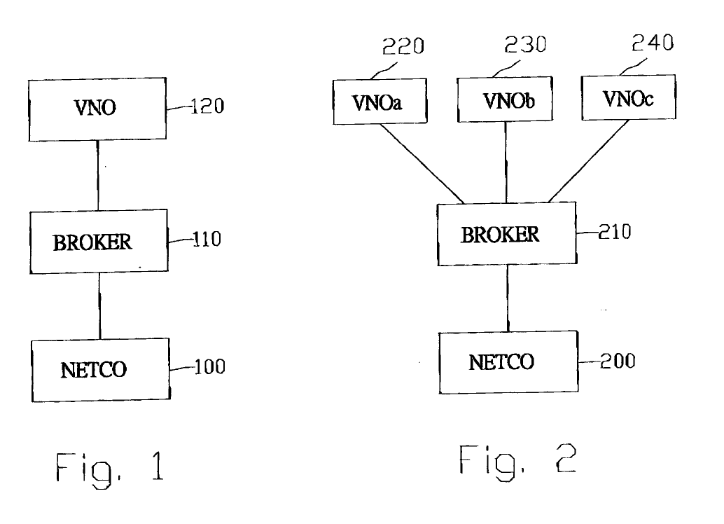

Refer to FIG. 1, which is a block diagram illustrating a network brokering method comprising a network company, a network broker, and a virtual network operator according to an embodiment of the present invention.

As shown in FIG. 1, the method of the present invention comprises a network company (NETCO) 100, a network broker 110, and a virtual network operator 120. As described above, the network company 100 provides the physical network such as the telephone lines, switches, and satellite equipment as well as various standard telephone services.

A virtual network operator (VNO) 120 is an operator that provides a virtual network to subscribers. Since the VNO 120 does not have its own network, it needs to lease, rent, or purchase access to and usage of the NETCO's 100 network. The VNO 120 is usually an organization with a well branded name or image, and one which typically wasn't previously associated as a network company.

Because the VNO 120 doesn't necessarily specialize in providing network services, the system can be difficult for the VNO 120 to develop by itself.

The network broker 110 is a mediator between the VNO 120 and the NETCO 100. The network broker 110 provides numerous services for both the NETCO 100 and the VNO 120. Following are some examples of the services that the network broker 110 provides.

The VNO 120 approaches the network broker 110 showing interest in establishing a virtual network. The network broker 110 works with the VNO 120 to determine their needs. After understanding the requirements that the VNO 120 has, the network broker 110 can suggest various options that are available and the advantages and disadvantages of each option. Issues such as usage volume, content, services, etc. need to be considered and discussed. When the VNO 120 and the network broker 110 have a good understanding as to the size of the project, the network broker 110 contacts the NETCO 100 to discuss fee and payment issues. The network broker 110 negotiates the details of the agreement in order to get the best service and pricing for the VNO 120. When the network broker 110 and the NETCO 100 have reached an agreement on such items as rates and volume, the network broker 110 contacts the VNO 120 with the details.

Obviously, the network broker 110 needs to make a profit, so terms of the agreements with the VNO 120 and the NETCO 100 includes conditions so that the arrangement is profitable. These conditions can comprise percentages, volume, range, time periods, rates, services, etc. For example, the network broker may prefer to add a predetermined percentage directly to the rates given by the NETCO 100.

Refer to FIG. 2, which is a block diagram illustrating a network brokering method comprising a network company, a network broker, and a plurality of virtual network operators according to an embodiment of the present invention.

In an embodiment of the present invention as illustrated in FIG. 2, the method comprises a NETCO 200, a network broker 210, and a plurality of VNO's. In FIG. 2, three VNO's are shown, VNOa 120, VNOb 130, and VNOc 140. However, no limit is intended as to the number of possible VNO's. For example, in some embodiments of the present invention, the number of VNO's is more than 10.

The method illustrated in FIG. 2 is similar to the embodiment shown in FIG. 1. However, in this embodiment the network broker 210 negotiates agreements with a multiple number of VNO's.

An advantage of this embodiment of the present invention is that the network broker 210 is able to negotiate a better rate since the total usage volume is a combination of all participating VNO's. As a result of the better pricing, the VNO's are more profitable, and due to the increased volume the NETCO 200 and the network broker 210 have increased revenue. If one of the VNO's had approached the NETCO 200 directly, not only would the service likely to be inferior, but the rates and pricing would be higher due to the small usage volume of a single VNO. With the bulk cooperation of a plurality of VNO's, the network broker 210 is able to enhance the system to the benefit of all participants.

Refer to FIG. 3, which is a block diagram illustrating a network brokering method comprising a plurality of network companies, a network broker, and a virtual network operator according to an embodiment of the present invention.

In the embodiment of the present invention as illustrated in FIG. 3, the method comprises a VNO 320, a network broker 310, and a plurality of NETCO's; NETCOa 300, NETCOb 305, and NETCOc 307.

The method illustrated in FIG. 3 is similar to the embodiment shown in FIG. 1. However, in this embodiment the network broker 310 negotiates agreements with a multiple number of NETCO's.

In FIG. 3, three NETCO's are shown, however, no limit is intended as to the number of possible NETCO's. For example, in some embodiments of the present invention, the number of NETCO's is more than 10.

An advantage to the embodiment as shown in FIG. 3 is that by comprising a multiple number of NETCO's, the method allows the network broker 310 to negotiate between competing NETCO's in order to get the best rates, terms, service, and conditions.

Additionally, the network broker 310 can switch between NETCO's. For example, if NETCOa 300 provides the best daytime rates and NETCOb offers the best nighttime rates, the network broker can arrange the system so that NETCOa's 300 network and services are utilized during the day and NETCOb's 305 network and services are used during the night. Alternatively, depending on the area or region, one NETCO may offer better service or pricing for this area. Therefore, according to the location, the network broker 310 can switch to the network of the NETCO with the best offer. Besides time, day, area, and location, other conditions such as volume can determine which NETCO the network broker 310 selects. Switching between NETCO's can be made immediately or scheduled. For example, the switch between NETCO's can be scheduled so that on weekends NETCOc's 307 network is utilized and on weekdays NETCOb's 305 network is utilized. Also, for example, if a NETCO's network suddenly becomes unstable, out of service, or unusable, another NETCO's network can be switched to immediately so that quality service is maintained for the VNO 320 and the subscriber.

The switching can also be made so that it is transparent to the VNO 320 and the subscriber if desired. In this way, the VNO 320 does not need to be concerned with the network details and can concentrate on improving their specialized services.

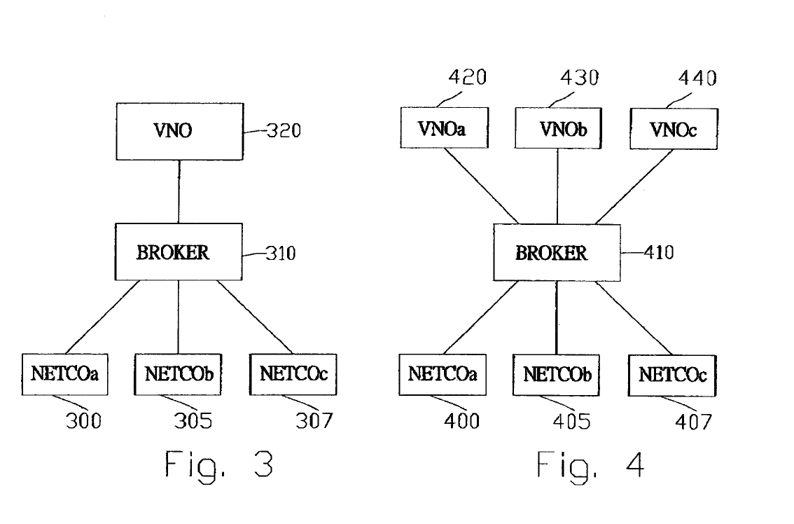

Refer to FIG. 4, which is a block diagram illustrating a network brokering method comprising a plurality of network companies, a network broker, and a plurality of virtual network operators according to an embodiment of the present invention.

In the embodiment of the present invention as illustrated in FIG. 4, the method comprises a plurality of VNO's; VNOa 420, VNOb 430, VNOc 440, a network broker 410, and a plurality of NETCO's; NETCOa 400, NETCOb 405, and NETCOc 407.

The method as illustrated in FIG. 4 is similar to FIGS. 2 and 3. However, in FIG. 4, the network broker 410 negotiates agreements with a plurality of NETCO's and a plurality of VNO's.

In FIG. 4, three NETCO's and 3 VNO's are shown, however, no limit is intended as to the number of possible NETCO's or VNO's. For example, in some embodiments of the present invention, the number of NETCO's and VNO's is more than 10 each.

The embodiment of the present invention as shown in FIG. 4 enjoys a combination of the benefits as described for the method in FIG. 2 and the benefits as described for the method in FIG. 3.

For example, an advantage the present invention is that the network broker 410 is able to negotiate a better rate since the total usage volume is a combination of all VNO's. As a result of the better pricing, the VNO's are more profitable, and due to the increased volume the NETCO 400 and the network broker 410 have increased revenue. If one of the VNO's had approached a NETCO directly, not only would the service likely to be inferior, but the rates and pricing would likely be higher. With the bulk cooperation of a plurality of VNO's, the network broker 410 is able to enhance the system to the benefit of all participants. Additionally, an advantage to this embodiment is that by comprising a multiple number of NETCO's, the method allows the network broker 410 to negotiate between competing NETCO's in order to get the best rates, terms, service, and conditions. The network broker 410 can also switch between NETCO's depending on various conditions in order to obtain the best deal.

Due to the combined traffic or usage of all the participating VNO's and the ability to switch between NETCO's, the network broker ensures efficient, high quality, and profitable communication networks and network services to virtual network operators and subscribers. The network broker also makes it easier and more convenient for VNO's to enter the network operator market.

The network is preferably a network for mobile telephone usage. However, utilizing the method for brokering networks of the present invention, the network can also be a telephone, wireless, cable, communication, satellite, or computer network or a combination of these networks.

As an example of implementation of the present invention, the following example is described. In the example, a well-know mobile telephone maker is interested in providing their own brand-name network services for customers who purchase their telephones. However, the telephone maker does not currently have their own physical network. Instead of incurring the enormous cost of establishing a network, the mobile phone manufacturer contacts a network broker. The network broker determines the services required and options available for developing the virtual network. The network broker negotiates with an established telephone company for usage of the telephone company's network. Upon conclusion of the agreement, the telephone maker is now a virtual network operator and has usage of the telephone company's network in order to provide network services to their customers. Since the telephone maker and their customers are probably most interested in advanced network services, the telephone maker can tailor their virtual network to provide specialized network services which may be unavailable elsewhere. In this way, the network broker helps the telephone maker easily and conveniently become a virtual network operator. Thereafter, when a customer purchases a telephone from the telephone maker, the telephone maker can provide network services under their brand name to the customer directly.

The above scenario is given only as an example of an implementation of the present invention. However, utilizing the method of the present invention, almost any type of company can enjoy the benefits of becoming a virtual network operator. Additionally, the method of the present invention allows all participating parties to increase revenue or profitability through increased usage or volume or lower rates.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A method for brokering network services comprising:
negotiating usage of networks and network services from a network company by a network broker; and
providing usage of the networks and network services to a virtual network operator by the network broker.

2. The method for brokering network services of claim 1, wherein the network broker negotiates with a plurality of network companies.

3. The method for brokering network services of claim 1, wherein the network broker provides to a plurality of virtual network operators.

4. The method for brokering network services of claim 3, wherein the network broker negotiates usage based upon a combined total usage of the plurality of virtual network operators.

5. The method for brokering network services of claim 2, wherein the network broker switches between different network companies' networks based on pricing, rates, availability, or quality.

6. The method for brokering network services of claim 5, wherein switching between networks is transparent to the virtual network operator.

7. The method for brokering network services of claim 1, wherein the network comprises a telephone, wireless, cable, communication, satellite, or computer network or a combination of these networks.

8. A method for brokering network services comprising:
negotiating usage of networks and network services from a plurality of network companies by a network broker;
providing usage of the networks and network services to a plurality of virtual network operators by the network broker; and
switching between the networks and network services of different network companies by the network broker.

9. The method for brokering network services of claim 8, wherein the network broker negotiates usage based upon a combined total usage of the plurality of virtual network operators.

10. The method for brokering network services of claim 8, wherein the network broker switches between different network companies' networks based on pricing, rates, availability, or quality.

11. The method for brokering network services of claim 8, wherein switching between networks is transparent to the virtual network operators.

12. The method for brokering network services of claim 8, wherein the network comprises a telephone, wireless, cable, communication, satellite, or computer network or a combination of these networks.

13. A method for improving network services comprising:
brokering usage of a network from a network company for a virtual network operator by a network broker.

14. The method of claim 13, wherein the network broker brokers usage from a plurality of network companies.

15. The method of claim 13, wherein the network broker brokers usage for a plurality of virtual network operators.

16. The method of claim 15, wherein the network broker negotiates usage based upon a combined total usage of the plurality of virtual network operators.

17. The method of claim 14, wherein the network broker switches between networks of different network companies based on pricing, rates, availability, service, or quality.

18. The method of claim 17, wherein switching between networks is transparent to the virtual network operator.

19. The method of claim 17, wherein the switching is performed according to a schedule or when predetermined criteria are met.

20. The method of claim 13, wherein the network comprises a telephone, wireless, cable, communication, satellite, or computer network or a combination of these networks.
